(19) United States
(12) Patent Application Publication
(10) Pub. No.: US 2004/0083178 A1
(43) Pub. Date: Apr. 29, 2004

(54) Contents providing system, and computer program, recording medium, terminal device and server used therefor

(75) Inventors: Toshifumi Tanaka, Tokyo (JP); Hiroyo Oouchi, Tokyo (JP); Takashi Namioka, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/384,362

(22) Filed: Mar. 7, 2003

(30) Foreign Application Priority Data
Mar. 12, 2002 (JP) 2002-067084

(51) Int. Cl. H04K 1/00

(52) U.S. Cl. 705/50

(57) ABSTRACT

A contents providing system is provided with a server which stores two or more contents files, a 1st terminal device which issues a recording medium recorded with download permission information for permitting download of at least one of the contents files is recorded and a 2nd terminal device which reads the download permission information from the recording medium and transmits it to the server. The server permits download of the corresponding contents file among the two or more contents files based on the download permission information transmitted from the 2nd terminal device.

### BACKGROUND OF THE INVENTION

1. Field of the Invention

The present invention relates to a contents providing system which can download contents such as music, images, application software and the like, and more particularly, to a system the user can utilize to receive desired contents easily and safely, and to view or use them.

2. Description of the Prior Art

Recent personal computers can connect with various contents providers, which provide music, images, application services and the like, through the Internet. Moreover, constant access to the Internet has become popular and utilization is spreading. Various contents such as music and movies are also continuously provided, and more and more cable television (CATV) services are also offering access to the Internet.

However, in order to view or use the contents, the user has to buy a subscription from the contents provider and, therefore, users sometimes have to sign up for unwanted programs. Subscriptions for individual channels and programs are available, but the subscription procedures are troublesome. Moreover, paying on-line when singing up for the contents involves some disadvantages such as leakage of personal information because the customer is required to input a credit card number and/or pin number.

To overcome these disadvantages, CATV services offer a system that charges a certain toll per viewed program, i.e., the pay-per-view system. However, such systems are limited to use for certain popular programs or for special short-term distributions. Furthermore, customers also have reason for concern about how reliably the personal information they submit when signing up for contents on-line is enciphered. Owing to these considerations, it has been difficult for users to receive desired contents easily and safely, and to view or use them.

### SUMMARY OF THE INVENTION

Therefore, an object of the present invention is to provide a contents providing system that the user can utilize to receive desired contents easily and safely, and to view and/or use them, and a computer program, recording medium, terminal device and server used therefor.

The above objects of the present invention can be accomplished by a contents providing system comprising a server which stores two or more contents files, a 1st terminal device which issues a recording medium recorded with download permission information for permitting download of at least one of the contents files, and a 2nd terminal device which reads the download permission information from the recording medium and transmits it to the server, which server permits download of the corresponding contents file among the two or more contents files based on the download permission information transmitted from the 2nd terminal device.

According to this aspect of the present invention, the download permission information is read from the recording medium utilizing the 2nd terminal device (the users terminal device), which is preinstalled with a downloader program, and transmitted to the server, and when the download permission information is ascertained to be valid by the server, the contents file can be downloaded, saved and reproduced by the 2nd terminal device. Accordingly, the user is saved the bother of taking troublesome procedures, such as subscribing for individual channels or programs, and can view or use the desired contents easily and safely. Moreover, users can cut expenses because they can receive contents-specific recording media and do not need to pay for unwanted contents. Furthermore, since the recording media can be sold in shops, leakage of the personal information, always a concern during on-line shopping, can be prevented. Since the customer has more flexibility in selecting contents, moreover, the number of customers using the contents providing system is likely to increase. Further, providers can be certain of collecting contents charges in advance of supplying contents.

The above mentioned objects of the present invention can also be accomplished by a recording medium recorded with download permission information for permitting download of at least one contents file among two or more contents files stored in a server.

According to this aspect of the present invention, the download permission information is read from the recording medium by the 2nd (user) terminal device and transmitted to the server, and when the download permission information is certified by the server, the contents file can be downloaded, saved and reproduced by the user terminal device. Accordingly, the user is saved the bother of taking troublesome procedures, such as subscribing for individual channels or programs, and can view or use the desired contents easily and safely. Moreover, users can cut expenses because they can receive content-specific recording media and do not need to pay for unwanted contents. Furthermore, since the recording media can be sold in shops, leakage of the personal information, always a concern during on-line shopping, can be prevented. Since the customer has more flexibility in selecting contents, moreover, the number of customers using the contents providing system is likely to increase. Further, providers can be certain of collecting contents charges in advance of supplying contents.

In a preferred aspect of the present invention, a contents file is recorded together with the download permission information.

According to this preferred aspect of the present invention, it is possible to view or use the contents without downloading the contents file, and to download and reproduce the contents file when the recording medium is damaged and the recorded contents cannot be reproduced. Moreover, other information can be recorded on the recording medium together with the download permission information. This makes it possible to offer an introduction to the contents and also to promote future downloads by the same user.

In a preferred aspect of the present invention, information specific to the terminal device which downloaded the contents file is further recorded.

According to this preferred aspect, downloading of the contents file by a terminal device other than the one that once downloaded it can be prevented by checking the specific information. Therefore, unrestricted copying of the contents file can be prevented.

In a preferred aspect of the present invention, the recording medium has a 1st recording area of a certain sector length in which the download permission information is recorded and a 2nd recording area of a sector length different from the 1st recording area.

According to this preferred aspect of the present information, since it is impossible to copy the data recorded on the recording medium wholly by the device driver of the OS installed in the terminal device, it is possible to prevent illegal copying of the download permission information.

In a further preferred aspect of the present invention, the recording medium has a 1st recording area in which it is possible to record and reproduce using a standard format and a 2nd recording area in which it is impossible to record and reproduce using the standard format, data for collation being recorded in the 2nd recording area.

According to this preferred aspect of the present invention, it is possible to ascertain whether a recording medium is an original by checking whether the data for collation recorded on the 2nd recording area can be read normally by the downloader.

In a preferred aspect of the present invention, the recording medium has pre-pits and is of at least write-once type, the download permission information being recorded using the pre-pits.

According to a further preferred aspect of the present invention, the downloaded contents file can be recorded without changing the download permission information.

In a preferred aspect of the present invention, the recording medium recorded with the download condition information defining download conditions is further recorded with a contents file.

According to this further preferred aspect of the present invention, duplication and misuse of contents file can be prevented by restricting the download based on the download condition information. Moreover, it becomes possible to permit downloading not only by the terminal device which once downloaded the contents file but also by other terminal devices. This enhances user convenience and prevents unrestricted duplication of the contents file.

In a preferred aspect of the present invention, the download condition information is the download number information and/or the download expiration date information.

According to this further preferred aspect of the present invention, duplication and misuse of the contents file can be prevented by restricting the number of downloads and the download period within the limits of common sense. Moreover, it makes it possible to permit downloading not only by the terminal device which once downloaded the contents file but also by other terminal devices, up to a certain number of times and/or within a certain period. This enhances user convenience and prevents unrestricted duplication of the contents file.

The above-mentioned objects of the present invention can also be accomplished by a computer program that causes a computer connected with a communication network to perform in succession the steps of accessing a server through the communication network, reading download permission information from a recording medium, transmitting the download permission information to the server is, and downloading the contents file from the server when the server permits the download based on the download permission information, the download permission information being information recorded on the recording medium for permitting download of at least one contents file among two or more contents files stored in the server.

According to this aspect of the present invention, by installing a special computer program called a downloader in the computer and running the downloader, the computer can be utilized as the terminal device for transmitting the download permission information for downloading the contents file from the server and downloading the contents file from the server if the server permits the download.

The above-mentioned objects of the present invention can also be accomplished by a recording medium recorded with the above-mentioned computer program.

According to this aspect of the present invention, by reading the downloader from the recording medium, installing it in the computer and running it, the computer can function as the terminal device and is enabled to transmit the download permission information for downloading the contents file from the server and download the contents file from the server if the server permits the download.

The above mentioned objects of the present invention can also be accomplished by a terminal device comprising means for accessing a server through a communication network, means for reading download permission information from a recording medium and transmitting it to the server, and means for downloading the contents file from the server when the server permits the download based on the download permission information, the download permission information being information recorded on the recording medium for permitting download of at least one contents file among two or more contents files stored in the server.

According to this aspect of the present invention, the terminal device can transmit the download permission information for downloading the contents file from the server and download the contents file from the server if the server permits the download.

The above mentioned objects of the present invention can also be accomplished by a computer program that causes a computer connected with a communication network to perform in succession the steps of communicating with a terminal device through the communication network, permitting download to the terminal device of a contents file among two or more contents files that corresponds to the download permission information transmitted from the terminal device, and supplying the contents file to the terminal device when the download is permissible based on the download permission information.

According to this aspect of the present invention, by installing the computer program in the computer and running the program, the computer can function as the server and is enabled to transmit the contents file upon determining that the download permission information transmitted from the terminal device is valid.

The above-mentioned objects of the present invention can also be accomplished by a recording medium recorded with the above mentioned computer program.

According to this aspect of the present invention, by reading the computer program from the recording medium, installing it in a computer and running the program, the computer can function as the server and is enabled to transmit the contents file upon determining that the download permission information transmitted from the terminal device is valid.

The above mentioned objects of the present invention can also be accomplished by a server comprising means for communicating with a terminal device through a communication network, means for storing a plurality of content files, means for permitting download of one contents file among the plural contents files that corresponds to the download permission information transmitted from the terminal device, and means for supplying the contents file when the download is permissible based on the download permission information.

According to the present invention, the server can transmit the contents file if the download permission information transmitted from the terminal device is ascertained to be valid.

The above mentioned objects of the present invention can also be accomplished by a terminal device comprising means for recording in a download recording medium download permission information for permitting download of at least one contents file among two or more contents files stored in a server, and a means for issuing the recording medium.

According to the present invention, users can freely choose desired contents from among many contents files by an easy operation, and the contents provider can reliably obtain payment for the contents.

### BRIEF DESCRIPTION OF THE DRAWINGS

FIG. 1 is a schematic diagram showing the configuration of a contents providing system that is a preferred embodiment of the present invention.

FIG. 2 is a flowchart for explaining the operation of the contents providing system in case of using an FD as a small capacity recording medium.

FIG. 3 is a data structure diagram showing other examples of the contents recorded in a recording medium 105.

FIG. 4 shows the track composition of an FD in which download permission information is recorded, wherein FIG. 4(a) shows a normal track configuration and FIG. 4(b) shows a track configuration having an abnormal sector.

FIG. 5 is a schematic elevation for explaining the track configuration of an FD.

FIG. 6 is a flowchart for explaining the operation of the contents providing system in the case of using an optical disk as a large capacity recording medium.

FIG. 7 is a data structure diagram showing other examples of the contents recorded in the recording medium 105.

FIG. 8 is a schematic diagram showing the configuration of a contents providing system that is another embodiment of the present invention.

FIG. 9 shows other examples of the contents recorded in the recording medium 105.

### DESCRIPTION OF THE PREFERRED EMBODIMENTS

Preferred embodiments of the present invention will now be explained with reference to the drawings.

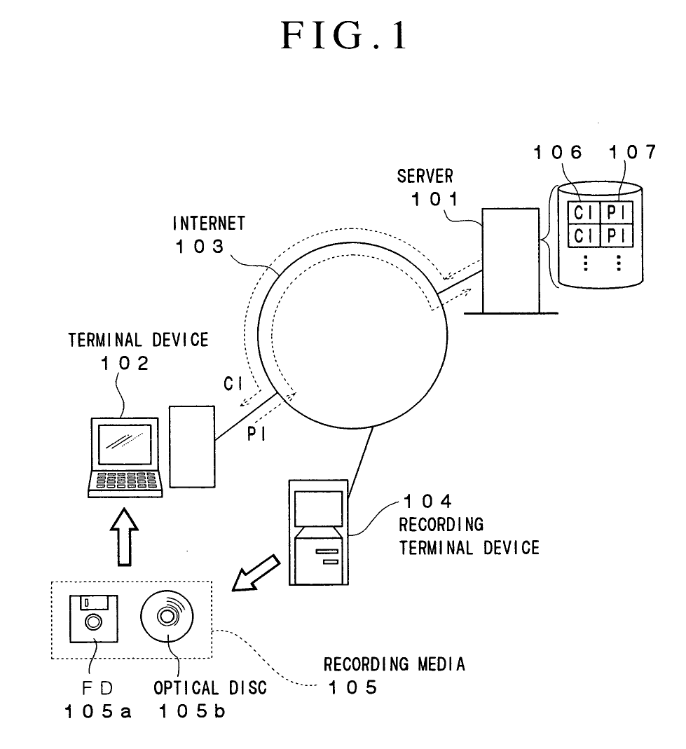

FIG. 1 schematically illustrates the configuration of a contents providing system that is a preferred embodiment of the present invention.

As shown in FIG. 1, the contents providing system has a server 101 managed by a provider offering contents providing services and a terminal device 102 that downloads contents file (CI) 106 from the server 101. The server 101 and the terminal device 102 are connected through the Internet 103.

The server 101 constitutes a database that stores a large number of contents files containing, for example, music, images, application software and the like. It also stores download permission information used to decide whether to permit or deny download of contents files.

The server 101 checks the validity of download permission information received from the terminal device 102 before permitting download of a contents file, supplies the contents file when the download permission information is valid, and so on. These functions are implemented by software (software for contents provision).

The terminal device 102 is, for example, a personal computer that includes a main unit, a keyboard, a display and the like. The main unit includes recording/reproducing devices, specifically a magnetic drive such as an FD drive that records and/or reproduces flexible disks and an optical drive that records and/or reproduces optical media such as CD-R, CD-RW, DVD-R, DVD-RAM and the like, and a hard disk drive. The terminal device 102 transmits the download permission information to the server 101 in order to request download of a contents file, receives the contents file from the server and saves it when the download of the contents file was permitted, and reproduces the contents. Furthermore, the terminal device 102 reads the download permission information recorded on an FD or an optical disk. This will be explained in detail later. These functions are implemented by software (a downloader program). When the downloader is run after being installed in the personal computer, the personal computer becomes a terminal device capable of downloading contents files, i.e., of downloading contents files from the server 101 through the Internet 103.

Further, a terminal device 104 for recording download permission information and issuing recording media recorded with download permission information (hereinafter called a “recording terminal device”) is connected to the Internet 103. The recording terminal device 104 enables the user to select desired contents, conducts cashing or electronic banking operations on providing the contents to the user, stores download permission information it downloads from the server 101, and records download permission information in the recording media 105, i.e., the FD 105a or optical disk 105b. These functions are implemented by hardware and software in the recording terminal device 104. The recording terminal device is, for example, installed at convenience stores, book stores, department stores, supermarkets or transportation terminals.

In the system of the forgoing configuration, a user who wishes view, listen to or use a certain contents product, first utilizes the recording terminal device 104 to acquire a recording medium 105 recorded with the download permission information for the desired contents. When the user chooses the desired contents and opens an account, the user is supplied with an FD 105a or optical disk 105b recorded with the download permission information for the contents file. At this time, the user can choose either an FD 105a or an optical disk 105b as the recording medium by operating the recording terminal device 104. Later, the user sets the medium in the terminal device 102 and begins to download the contents file.

The download permission information may establish one item of permission information for one contents file or multiple items of permission information for one contents file, or each recording medium may contain different permission information established for the same contents file.

The terminal device 102 reads the download permission information recorded on the FD 105a or the optical disk 105b and transmits it to the server 101 to request a download. Upon receiving a request for a download from the terminal device 102, the server 101 checks the validity the download permission information received from the terminal device 102 before permitting the download of the contents file. When the server 101 confirms that the download permission information is valid, i.e., that download can be permitted, the server 101 chooses the contents file corresponding to the download permission information from the database and transmits it. If the download permission information is found to be invalid, the server denies the request to download and so informs the requester.

When the request is accepted, the terminal device 102 receives the contents file sent from the server 101 and saves it on the hard disk. The contents file may be saved on the recording medium 105 together with the download permission information. The saved contents file can be reproduced using the downloader running on the terminal device 102 or using any of various generally available contents players. Furthermore, the terminal device 102 can download a contents file from the server 101 and play it in streaming mode without saving it on the hard disk.

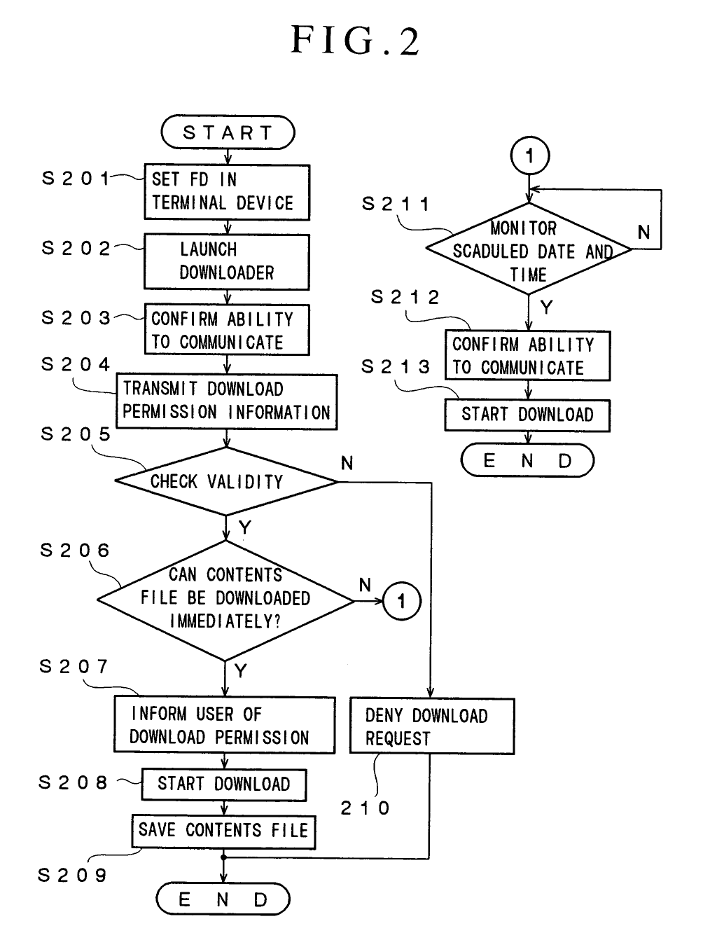

FIG. 2 is a flowchart explaining the operation of the contents providing system in the case of using an FD, i.e., a small capacity recording medium.

As shown in FIG. 2, the user first acquires the FD 105a recorded with the download permission information for the desired contents using the recording terminal device 104, and sets it in the terminal device 102 (S201). Next, the user confirms whether the downloader is running, and launches it if it is not (S202).

Once the downloader is active, the terminal device 102 first confirms that communication with the server 101 is possible (S203) and then reads the download permission information recorded on the FD and transmits it to the server 101 (S204) to request a download. Upon receiving the request for a download from the terminal device 102, the server 101 checks the validity of the download permission information received from the terminal device 102 (S205). At this time, it is checked whether the contents file can be downloaded immediately or on or after a predetermined date and/or time (S206). This check is made because there are various types of contents, such as programs that are broadcast at a certain date and time, every week, only on weekdays, only on weekends, or serially but not at regular times. The validity check for the download is therefore performed in accordance with how the download will be conducted and the user is informed of the download permission (denial) (S207).

When an immediate download is possible, the user starts the download by certain operation, such as by pushing a “download button” (S208), the contents file corresponding to the download permission information is transmitted from the server 101, the terminal device 102 saves it on the hard disk (S209), and the download is completed. If request is invalid, the server denies the download request and so informs the user (S210).

When it is possible to conduct the download at a predetermined date and time, the downloader is scheduled to make the download of the contents file at the appropriate time. The download program monitors the scheduled date and time (S211). When the downloader is launched at the scheduled date and time (S211Y), a confirmation is made as to whether it is possible to communicate with the server 101 (S212), and if it is the download is started (S213).

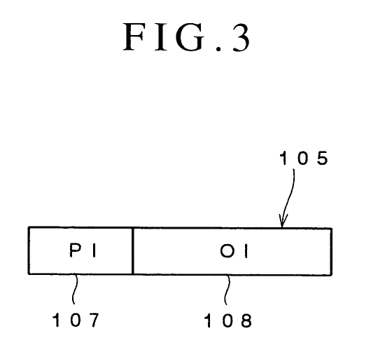

FIG. 3 is a data structure diagram showing other examples of the contents recorded in the recording medium 105.

As shown in FIG. 3, in order to prevent illegal copying of the download permission information recorded on a recording medium, such as the FD 105a, optical disk 105b or the like, the terminal device-specific information (OI) 108 is recorded at the time of first access to the FD 105a or the optical disk 105b recorded with the download permission information (PI) 107. Examples of such terminal device-specific information 108 include, but are not limited to, IP (Internet Protocol) address, MAC (Media Access Control) address, computer name and the like.

When the specific information 108 is recorded on the recording medium 105, the server can deny a download request originating from another terminal device because if the recording medium is set in the other terminal device and an attempt is made to use a downloader conduct a download, the terminal-specific information of the terminal device will not agree with that recorded on the recording medium. Therefore, unrestricted copying of contents files can be prevented.

Illegal copying after the FD has been accessed can prevented by the above-mentioned method. Prevention of illegal copying before the FD is achieved by a 1st method of formatting so that an abnormal sector is formed and/or a 2nd method that uses an over-track.

The 1st method will now be explained. In order to prevent illegal copying before the FD has been accessed, it is effective to format the FD so that an abnormal sector is formed.

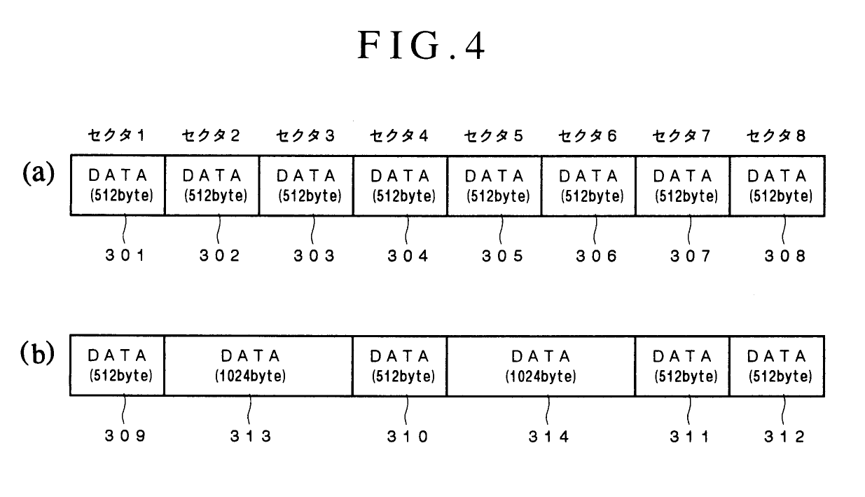

FIG. 4(a) and FIG. 4(b) shows the track configuration of an FD in which download permission information is recorded, wherein FIG. 4(a) is a normal track configuration and FIG. 4(b) is a track configuration having an abnormal sector.

As shown in FIG. 4(a), there are, for example, 8 sectors 301-308 per track in the FD formatted by the standard formatter included in the OS of the terminal device. Each sector includes 512 byte DATA fields (user recording area). While both an ID field and a DATA field are present in each sector, the ID field, which consists of only a small amount of data, is omitted, and DATA field is defined as the substantial sector length.

On the other hand, in the method of using an abnormal sector, the formatting is, as shown in FIG. 4(b), performed so that 512 byte sectors 309-312 and 1024 byte sectors 313 and 314 are formed alternately in the user recording area of the FD. Namely, the latter sectors, which have different sector length (1024 bytes) from the ordinary sector length (512 bytes), are formed intentionally on a suitable track in the user recording area (one where download permission information and the like are not recorded) in the FD, i.e., a track that is not usually used is formed. Further, the download permission information is recorded in the area of 512 byte sector length.

If the FD is copied using the copy command of the OS installed in the terminal device, the copy will not be completed and an error will occur owing to the inclusion of the abnormal track. The formatting of the FD in this manner thus prevents stored data from being copied before the FD is accessed by the downloader. Therefore, it is possible to prevent illegal copying of the FD.

Moreover, the prevention of illegal copying of the download permission information can be achieved not only by changing the sector length alternately as explained in the foregoing but also by setting the sector length constant but intentionally forming bad sectors or bad blocks on the tracks.

The 2nd method will now be explained. In order to prevent illegal copying by reading or writing real data, which the above-mentioned 1st method cannot prevent, it is effective to utilize an over-track.

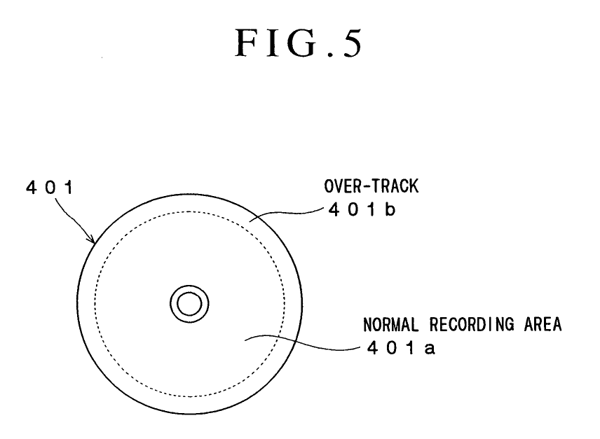

FIG. 5 is a schematic elevation for explaining the track configuration of an FD.

As shown in FIG. 5, data for collation is recorded on an over-track 401b present outside of the normal recording area 401a and in a track area where it cannot be utilized normally.

The normal recording area 401a can be recorded using the standard format by a standard device driver included in the OS of the terminal device 102. However, it is impossible to record on the over-track 401b using the standard format. The FD drive of the recording terminal device 104 is utilized for recording the download permission information.

Whether or not an FD is an original can be discriminated by checking whether the data for collation recorded on the over-track 401b can be read normally by the device driver contained in the downloader installed in the terminal device 102. Furthermore, it is also possible to form the over-track as an abnormal track according to the 1st method.

The large-capacity optical disk can be used as an effective means for enabling storage of the downloaded contents file together with the download permission information disk. In this case, a write-once type optical disk recorded with the prescribed download permission information in the form of pre-pits is supplied. The optical disks can be made available to customers by putting them on sale at shops or by accepting orders by e-mail or the like beforehand and then delivering the disk to the customer through a shop or delivery service.

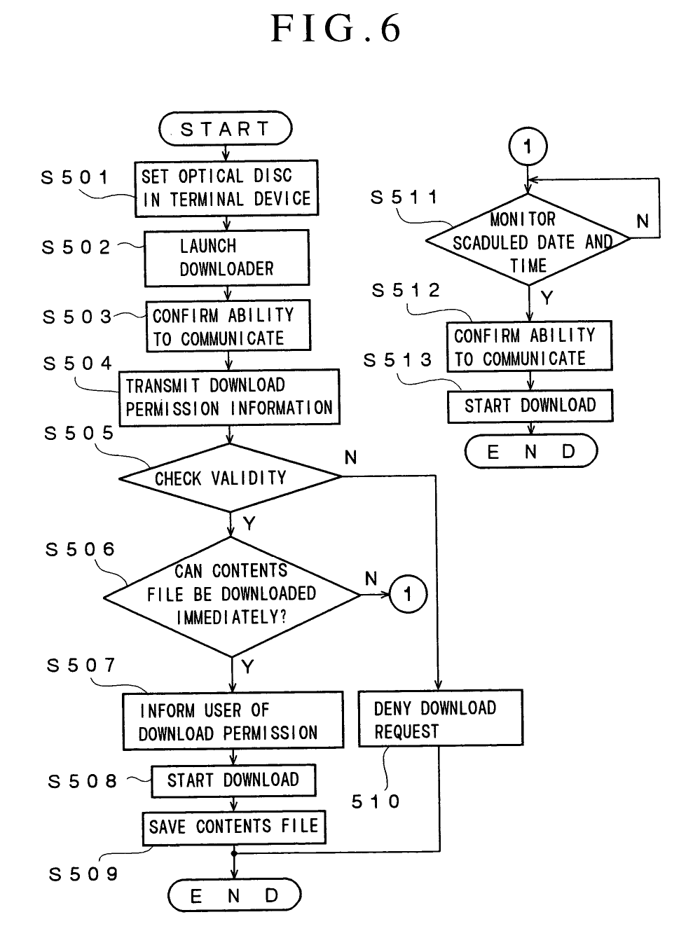

FIG. 6 is a flowchart for explaining the operation of the contents providing system in the case of using the optical disk as a large capacity recording medium. As shown in FIG. 6, a user first acquires the optical disk 105b recorded with the download permission information for the desired contents and sets it in the terminal device 102 (S501). Next, the user confirms whether the downloader is running and launches it if it is not (S502).

Once the downloader is active, the terminal device 102 confirms that communication with the server 101 is possible (S503) and then reads the download permission information recorded on the optical disk and transmits it to the server 101 (S504) to request a download. Upon receiving the request for a download from the terminal device 102, the server 101 checks the validity of the download permission information received from the terminal device 102 (S505). At this time, it is checked whether the contents file can be downloaded immediately, or on or after a predetermined date and time (S506). As mentioned above, this check is made because there are various types of contents and the validity check for the download is therefore performed in accordance with how the download will be conducted and the user is informed of the download permission (denial) (S507).

When an immediate download is possible, the user starts the download by a certain operation, such as by pushing a “download button” (S508), the contents file corresponding to the download permission information is transmitted from the server 101, the terminal device 102 saves it on the optical disk 502b or the hard disk (S509), and the download is completed. If the request is invalid, the server denies the download request and so informs the user (S510).

When it is possible to conduct the download at a predetermined date and time, the downloader is scheduled to make the download of the contents file at the appropriate time. The download program monitors the scheduled date and time (S511). When the downloader is launched at the scheduled date and time (S511Y), a confirmation is made as to whether it is possible to communicate with the server 101 (S512), and if it is the download is started (S513).

Similarly to what was explained earlier, if the download permission information is supplied on FDs or optical recording disks, users can download desired contents easily and safely simply by acquiring an FD or optical disk. Therefore, by making the FD and/or optical disk available at shops, the contents provider can easily and reliably obtain payment for the contents.

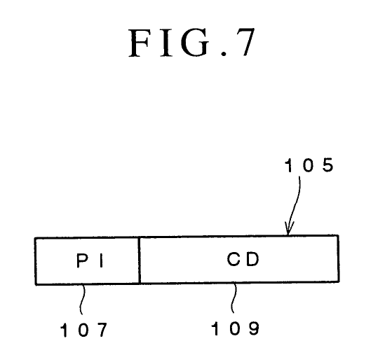

FIG. 7 is a data structure diagram showing other examples of the contents recorded in a recording medium 105.

As shown in FIG. 7, it is preferable to record download condition information (CD) 109 defining contents file download conditions in the recording medium 105, e.g., the FD 105a and/or optical disk 105b, together with the download permission information for the contents. Such conditions might include, for example, download number information for limiting the number of contents file downloads and download expiration date information for defining the expiration date of the period during which downloading is permissible.

If download number information is recorded together with the download permission information on the recording medium, for example, the server 101 checks whether the download is permissible based on the download permission information and compares the download number information recorded in the recording medium 105 and transmitted to the server 101 against information regarding the number of previous downloads recorded in the server 101.

Thus, even if download is permissible based on the download permission information, the server 101 denies the download request if the number downloads has exceeded the limit defined by the download number information.

If download expiration date information is recorded together with the download permission information on the recording medium, for example, the server 101 checks whether the download is permissible based on the download permission information and checks the download expiration date information read from the recording medium 105 and transmitted to the server 101 by the terminal device 102.

Thus, even if the download is permissible based on the download permission information, the server 101 denies the download request if the download expiration data has passed.

Thus, if the download number information and the download expiration date information are recorded on the recording medium, duplication and misuse of the contents file can be prevented by restricting the number of downloads and the download period within the limits of common sense. Moreover, it becomes possible to permit downloading not only by the terminal device which first downloaded the contents file but also by other terminal devices. This enhances user convenience and prevents unrestricted duplication of contents files.

Furthermore, it is possible to allow the customer to return the recording medium for a refund if not even one download is made within the download period. In this case, if the recording terminal device 104 (FIG. 1) is equipped with functions for collecting unused recording medium and, after a recording medium is set therein, is capable of checking with the server 101 as to whether the recording medium has been used to download the contents file, it becomes possible to automatically return unused recording medium at convenience stores and other locations where the recording terminal device 104 is installed.

In addition, either or both of the download number information and download expiration date information may be recorded as the download condition information 109. If both are recorded, unrestricted duplication can be prevented much more effectively. The download condition information is not limited to the download number information and the download expiration date information, and it is possible to include various conditions in the download condition information, such as download-permissible area, date and the like.

Although the case where a personal computer is used as a terminal device was explained in the embodiment, the invention is not limited to use of a personal computer and it is possible instead to use, for example, a network compatible CD/DVD player, CATV or the like.

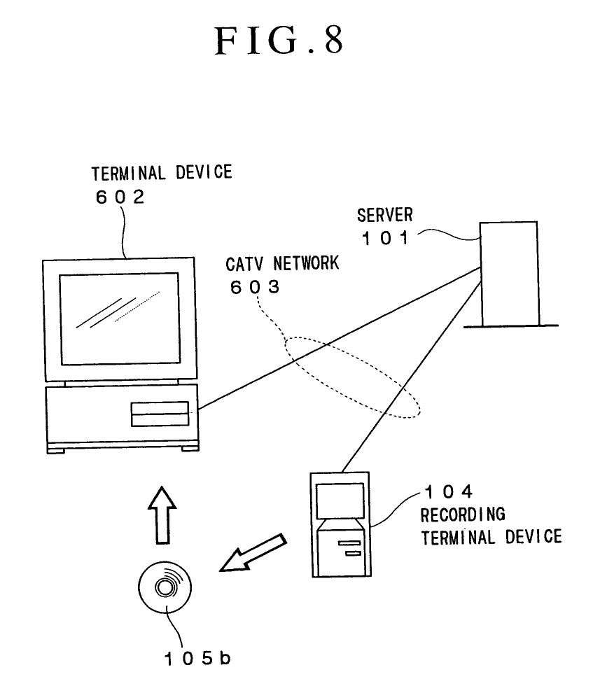

FIG. 8 is a schematic diagram showing the configuration of a contents providing system that is another embodiment of the present invention. In FIG. 8, constituents corresponding to those in the first embodiment are assigned the same reference symbols as in the first embodiment and will not be explained again. This embodiment applies to a CATV network.

As shown in FIG. 8, the contents providing system has a server 101 managed by a provider offering contents providing services and a terminal device 602 which downloads contents file (CI) from the server 101. The server 101 and terminal device 602 are connected through a CATV network 603, which is one type of the communication network.

The terminal device 602 includes a CATV tuner, an optical drive which records and/or reproduces optical media such as CD, CD-R, CD-RW, DVD, DVD-R, DVD-RAM and the like and a hard disk drive.

The terminal device 602 transmits the download permission information to the server 101 in order to request download of a contents file, receives the contents file from the server 101 and saves it when the download of the contents file was permitted, and reproduces the contents. Furthermore, the terminal device reads the download permission information recorded on an FD or and optical disk. These functions are implemented by firmware (a downloader).

In the system of the foregoing configuration, a user who wishes view, listen to or use a certain contents product, first acquires the recording medium 105 recorded with the download permission information for the desired contents. Next, the user sets the medium in the terminal device 602 and begins to download the contents file.

Terminal device 602 reads the download permission information recorded on the optical disk 105b and transmits it to the server 101 to request a download. Upon receiving the request for a download form the terminal device 602, the server 101 checks the validity of the download permission information received from the terminal device 602 before permitting the download of the contents file. When the server 101 confirms that the download permission information is valid, i.e., that download of the contents file can be permitted, the server 101 chooses the contents file corresponding to the download permission information from the database and transmits it. If the download permission is found to be invalid, the server denies the request to download and so informs the requester.

When the request is accepted, the terminal device 602 receives the contents file sent from the server 101 and saves it on the hard disk. The saved contents file can be reproduced using the downloader running on the terminal device 602. Furthermore, the terminal device 602 can also play the contents file in streaming mode without saving it on the hard disk.

As explained above, the user can download the desired contents utilizing the CATV network just as easily and safely as when utilizing the Internet.

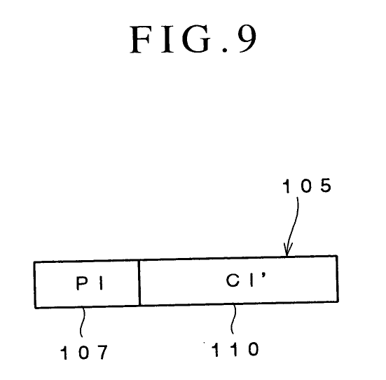

FIG. 9 shows other examples of the contents recorded in the recording medium 105.

Although the case in which the download permission information (PI) 107 is provided by the recording terminal device 104 as recorded on a recording medium 105 such as a FD or an optical disk was explained in the first embodiment, in this embodiment, as shown in FIG. 9, it is possible to provide a recording medium recorded with not only the download permission information (PI) 107 but also a contents file (CI′) other than the contents file that can be downloaded using the download permission information. For example, the recording medium 105 can be recorded with download permission information for downloading the contents file of a certain movie and also with a contents file of a digest of the movie or a preview of another movie. Otherwise it can be recorded with download permission information for downloading the contents file of a certain music product together with a contents file containing an introduction to a new music release in the same genre or a genre related to the downloadable music.

The present invention has thus been shown and described with reference to specific embodiments. However, it should be noted that the present invention is in no way limited to the details of the described arrangements but changes and modifications may be made without departing from the scope of the appended claims.

For example, in the above-described embodiments, explanation was made regarding the case where information specific to the terminal device which first downloaded the contents file is recorded on an FD. However, the invention is not limited to this arrangement and it is instead possible to record sequentially on the FD information specific to multiple terminal devices beginning with information specific to the terminal device that first downloaded the contents file. In such case, download by two or more terminal devices can be permitted.

Moreover, in the above described embodiments, explanation was made regarding the case where pre-pits are formed on optical disks, and the download permission information is recorded using the pre-pits. However, the use of pre-pits is not limited to optical disks, but can be applied to other optical recording media and magneto-optical recording medium such as MO. Furthermore, the recording medium is not limited to disk type and can be square type or stick type.

As described above, in the present invention, the download permission information is read from the recording medium and transmitted to the server utilizing the terminal device installed with downloader, and when the download permission information is determined to be valid, the contents file is supplied and can be saved and reproduced by the terminal device. Accordingly, the user is saved the bother of taking troublesome procedures such subscribing for individual channels or programs and can view or use the desired contents easily and safely.

Moreover, users can cut expenses because they can obtain just the desired contents individually and do not need to pay for unwanted contents. Furthermore, since the recording media can be sold in shops, leakage of the personal information, always a concern during on-line shopping, can be prevented.

Moreover, since the customer has more flexibility in selecting contents, the number of customers using the contents providing system is likely to increase. Further, providers can be certain of collecting contents charges in advance of supplying contents.

In addition, providers need to supply only the number of contents files ordered by customers. Unlike in the past, therefore, the provider does not have to manufacture products based on projected demand or be concerned about stock excesses.

What is claimed is:

1. A contents providing system comprising:
a server which stores two or more contents files;
a 1st terminal device which issues a recording medium recorded with download permission information for permitting download of at least one of the contents files is recorded; and
a 2nd terminal device which reads the download permission information from the recording medium and transmits it to the server, which server permits download of the corresponding contents file among the two or more contents files based on the download permission information transmitted from the 2nd terminal device.

2. A recording medium recorded with download permission information for permitting download of at least one contents file among two or more contents files stored in a server.

3. The recording medium according to claim 2, wherein a contents file is recorded together with the download permission information.

4. The recording medium according to claim 2, wherein information specific to the terminal device which downloaded the contents file is further recorded.

5. The recording medium according to claim 2, which recording medium has a 1st recording area of a predetermined sector length and in which the download permission information is recorder and a 2nd recording area of a sector length different from the 1st recording area.

6. The recording medium according to claim 2, which recording medium has a 1st recording area in which it is possible to record and reproduce using a standard format and a 2nd recording area it which it is impossible to record and reproduce using the standard format, data for collation being recorded in the 2nd recording area.

7. The recording medium according to claim 2 which has pre-pits and is at least write-once type, wherein the download permission information is recorded suing the pre-pits.

8. The recording medium according to claim 2, which recording medium is further recorded with download condition information defining conditions for downloading the contents file.

9. The recording medium according to claim 8, wherein the download condition information is download number information and/or download expiration date information.

10. A computer program that causes a computer connected with a communication network to perform in succession the steps of:
accessing a server through the communication network;
reading download permission information from a recording medium;
transmitting the download permission information to the server; and
downloading the contents file from the server when the server permits the download based on the download permission information,
the download permission information being information recorded on the recording medium for permitting download of at least one contents file among two or more contents files stored in the server.

11. A recording medium recorded with a computer program that causes a computer connected with a communication network to perform in succession the steps of:
accessing a server through the communication network;
reading download permission information from a recording medium;
transmitting the download permission information to the server; and
downloading the contents file from the server when the server permits the download based on the download permission information,
the download permission information being information recorded on the recording medium for permitting download of at least one contents file among two or more contents files stored in the server.

12. A terminal device comprising:
means for accessing a server through a communication network;
means for reading download permission information from a recording medium and transmitting it to the server; and
means for downloading the contents file from the server when the server permits the download based on the download permission information,
the download permission information being information recorded on the recording medium for permitting download of at least one contents file among two or more contents files stored in the server.

13. A computer program that causes a computer connected with a communication network to perform in succession the steps of:
communicating with a terminal device through the communication network;
permitting download to the terminal device of a contents file among two or more contents files that corresponds to the download permission information transmitted from the terminal device; and
supplying the contents file to the terminal device when the download is permissible based on the download permission information.

14. A recording medium recorded with a computer program that causes a computer connected with a communication network to perform in succession the steps of:
communicating with a terminal device through the communication network;
permitting download to the terminal device of a contents file among two or more contents files that corresponds to the download permission information transmitted from the terminal device; and
supplying the contents file to the terminal device when the download is permissible based on the download permission information.

15. A server comprising:
means for communicating with a terminal device through a communication network;
means for storing a plurality of content files;
means for permitting download of one contents file among the plural contents files that corresponds to the download permission information transmitted from the terminal device; and
means for supplying the contents file when the download is permissible based on the download permission information.

16. A terminal device comprising:
means for recording in a recording medium download permission information for permitting download of at least one contents file among two or more contents files stored in a server; and
means for issuing the recording medium.
